(19) United States
(12) Patent Application Publication
(10) Pub. No.: US 2009/0292381 A1
(43) Pub. Date: Nov. 26, 2009

(54) PRODUCTION PLANNING METHOD AND PRODUCTION PLANNING SYSTEM FOR MIXED FLOWS OF PRODUCTION BY ORDER AND FORECASTING

(76) Inventors: Shota Inoue, Kawasaki (JP); Tomoyuki Aoki, Tokyo (JP); Yuichi Nakamura, Kawasaki (JP); Takaaki Yoshida, Tokyo (JP)

Correspondence Address: MATTINGLY & MALUR, P.C., 1800 DIAGONAL ROAD, SUITE 370, ALEXANDRIA, VA, 22314, US

(21) Appl. No.: 11/813,048

(22) PCT Filed: Sep. 8, 2006
(86) PCT No.: PCT/JP2006/317886

§ 371 Date: Oct. 28, 2008

(30) Foreign Application Priority Data
Sep. 9, 2005 (JP) 2005-261567

(51) Int. Cl. G06F 17/00; G06Q 10/00; G06Q 50/00

(52) U.S. Cl. 700/101; 700/103; 705/10; 705/7

(57) ABSTRACT

In the production process where an ordered article and a forecast production article are mixed, parameters for defining production priority of each article are preset while assuming a case where the demand exceeds the available production capability, and priority is given to an article which must be produced first within the range of available production capability according to the marginal stock rate of each article. The marginal stock rate is determined by (effective stock amount/necessary stock amount) for a forecast production article. As for the ordered production article, a stock sufficient for delivery is required at the time of shipment. Accordingly, stock of that quantity (demand take-in amount) can be regarded as the necessary amount of stock while the currently completed products can be regarded as the effective stock amount. Thus, the marginal stock rate (effective stock amount/demand take-in amount) can be indexed.

### INCORPORATION BY REFERENCE

The present invention claims priority for JP 2005-0261567 filed on Sep. 9, 2005, the content of which is hereby incorporated by reference into this application.

### TECHNICAL FIELD

The present invention is applied to the technical field relating to a production planning method and a production planning system involving mixture of flows (hereinafter, referred to as mixed flows) of a production process where an article whose production is decided to be started after an order from a customer is received (hereinafter, referred to as an ordered production article) and an article which is produced before receiving an order from a customer and its stock is shipped after an order is received from a customer (hereinafter, referred to as a forecast production article), and in particular, to the technical field relating to a production planning method and a production planning system in which a production priority (capability distribution) should be decided for the ordered production article and the forecast production article because the amount of products which can be obtained in a unit period of process is limited.

### BACKGROUND ART

Conventionally, when creating a production plan, the forecast production plan and the ordered production plan have been created according to different ideas concerning the capability distribution of production process.

In the ordered production, capability is distributed according to an article and its amount actually ordered by a customer, i.e., according to the available production capability or the production process and the definite ordered amount. The products produced are all shipped to the customer and no surplus stock or dead stock are generated. However, for the article which is continuously ordered by a customer or an article which is desired to be shipped immediately, it is necessary to maintain a certain stock and answer the request from a customer. As a production method to satisfy this requirement, the forecast production is known. In the forecast production, a production plan is created according to the stock standard which is required statistically so as to obtain a safe stock amount not causing a surplus stock or insufficient stock.

Some of the articles are produced by a production plan based only on the ordered production or the forecast production. However, according to a production management data handling, even an article on the same production process may require handling of the article as an ordered production article and as a forecast production article so that the both production methods are mixed to create a production plan (mixed-flow production). For the forecast production, a production plan is created by referencing the past production amount and is not based on a definite order. Accordingly, if a production demand is changed and a new ordered production article is generated, the available production capability of the process is modified and the ordered production article is distributed to the process capability with a higher priority than the forecast production article. This is because the ordered article should be shipped at an early stage and the shipment causes take-out from the stock.

JP 2004-287491 discloses a production plan creation method for mixing an ordered production article and a forecast production article so as to minimize the stock amount while considering an unusable period of the production facility.

### DISCLOSURE OF INVENTION

### Problem to be Solved by the Invention

In the production process where a flow of an ordered production article and a flow of a forecast production article are mixed, if the ordered production article is always produced with a high priority because the ordered production article is a definite matter, the minimum stock amount of the article of the forecast production which should be theoretically maintained becomes insufficient. To cope with this, in order to maintain an optimal stock amount of the forecast production article, there is an idea to maintain a stock amount not causing insufficient stock or surplus stock by the stock refilling method for the product stock (“Evaluation of optimized stock management method for mixed flows of ordered and forecast production” (Japan Electric Technology Association, March 2000)). However, when the total of demands of an ordered production article and a forecast production article exceeds the available production capability of the process, a production planner often adjusts the production by advancing or delaying the production schedule according to his/her intuition and experience. As a countermeasure for this, “Evaluation of optimized stock management method for mixed flows of ordered and forecast production” (Institute of Electrical Engineers of Japan, March 2000) introduces a method for calculating a necessary stock amount as a result for the forecast production article and making the stock amount as a target value of production. However, there has not been a system for combining, on the same level, the ordered production having no concept of the stock and the forecast production where the stock management is a factor in making a plan so as to create a production plan for mixed-flow production as capability distribution of the production process.

It is therefore an object of the present invention to provide a production planning method and a production planning system for automatically carrying out production adjustment even when a demand for each of articles is changed in the mixed-flow production process where an ordered production article and a forecast production article are mixed.

### Means for Solving the Problem

In order to achieve the aforementioned object, the production planning method according to the present invention introduces a marginal stock rate considering the concept of a stock into an ordered production and uses the same marginal stock rate as an index also in a forecast production so as to decide a production priority and allocate a production process. That is, in a production planning method of the production process where flows of an ordered production article and a forecast production article are mixed, the production type of a production article is identified and a parameter defining the production priority based on the production type is acquired. When the acquired parameter is lower than a predetermined value, the capability distribution of the production line and the production amount are decided for the production article.

Moreover, the present invention provides a production planning method as follows. That is, production plan data containing an ordered production article and a forecast production article are read-in to acquire a marginal stock rate by using different calculation processes for the ordered production article and the forecast production article. Marginal stock rates for all the production articles for which a production plan is to be created are stored in a single table so as to decide a production line and a production amount for producing a production article whose marginal stock rate stored in the table is lower than a predetermined value.

Moreover, the present invention provides a production planning system for reading-out following processing programs stored in a storage device and executing them:

a data input program for inputting data from the storage device and from outside;

a production type judging program for judging the production type of a production article for which a production plan is to be created, i.e., whether the article is an ordered production article or a forecast production article;

an ordered production article calculation program for acquiring a marginal stock rate (1) for the production article whose production type is judged to be an ordered production;

a forecast production article calculation program for acquiring a marginal stock rate (2) for the production article whose production type is judged to be a forecast production;

a minimum marginal stock rate judging program for writing the marginal stock rate (1) and the marginal stock rate (2) in a single table and identifying a production article corresponding to a minimum marginal stock rate smaller than 1;

a capability distribution decision program for allocating a production process for the identified production article; and

a production amount calculation program for deciding a production amount of the identified production article in the allocated production process.

### ADVANTAGES OF THE INVENTION

Since a production instruction can be performed in accordance with a demand change of each article within an available production capability in a production process where flows of an ordered production article and a forecast production article are mixed, it is possible to maximize the future demand sufficiency of both of the ordered production article and the forecast production article and to reduce the number of production adjustment steps. Even if a demand exceeding the available production capability is generated, it is possible to rapidly decide the priority of the article which is to be produced first and maximize the order sufficing rate of the articles even in the mixed flows of production process.

### BEST MODE FOR CARRYING OUT THE INVENTION

Description will now be directed to an embodiment of the present invention with reference to the drawings.

FIG. 1 is a block diagram showing configuration of an entire system according to the present embodiment. A computer processing device 1 is connected to a storage device 2, a display device 3, an input device 4, a printer 5, and to a plurality of computers/terminals 7 via a network 6. The processing device 1 includes a memory 20 containing a data input program 11, a production type judging program 12, an ordered production article calculation program 13, a forecast production article calculation program 14, a minimum marginal stock rate judging program 15, a distribution line decision program 16, a production amount calculation program 17, a production plan output program 18, and a database access program 19, which are read out to a processing unit 8 so as to be executed. The storage device 2 contains tables including a production plan table 201 and actual demand information 217 as production plan data. The entire configuration of each table is shown in FIG. 3 and their details are shown in FIG. 12 to FIG. 19. The display device 3 displays a guide screen view for inputting data and a capability distribution result which has been created. The input device 4 is used for inputting data to be set in the various tables and a parameter for executing a program. The printer 5 is used to output the capability distribution result table created and the like. The computers/terminals 7 are server computers or terminal devices installed in a warehouse, a production section, and the like including a terminal device for inputting data to be set in a table and a computer for receiving the production amount calculation table.

FIG. 2 shows an assumed model used for explaining the present embodiment. A mixed-flow process for producing an ordered article A (21), an ordered article B (22), a forecast article C, and a forecast article D uses a first line (23), a second line (24), and a third line (25). Articles produced in the respective lines are stored in stock points from stock A (26) to stock D (29). As for the arrows connecting the ordered articles and the respective lines, the ordered article A (21) is connected to every lines from the first to the third line. This means that parts or materials of the ordered article A (21) can be produced by the production process of any of the lines from the first to the third line. The ordered article B (22) is connected by arrows to the first and the third line. This means that parts or materials of the ordered article B can be produced by the production process of the first line (23) or the third line (25) but cannot be produced by the second line (24). The arrows directed from the respective lines of the mixed-flow process to the stock points indicate stock groups where articles produced by the respective lines are stored. An article which has passed through the first line (23) is stored as a stock A (26), a stock B (27), or a stock C (28). It should be noted that any of the first, the second, and the third line constituting a process of the production plan corresponds to the line of the present embodiment regardless of the form of the process. For example, the line includes all the processes such as an assembly line where an article is conveyed on a belt conveyer while being assembled, a cell production method where a plurality of steps are performed at one position, and a step of chemical reaction in a furnace such as a chemical plant.

FIG. 3 shows data configuration stored in the storage device 2, i.e., contents of the respective tables from a production plan table 201 to actual demand information 217 and main relationships between the tables. FIG. 4 to FIG. 11 are flowcharts indicating the process of the present embodiment. FIG. 12 to FIG. 19 show specific examples of data items of FIG. 3 as data tables stored in the storage device 2.

Explanation will be given on the data items shown in FIG. 3.

The production plan table 201 is basic information on an object article of the production plan and is provided for each “article code”. “L” represents a supply lead time, i.e., a period required from the moment when production of the article is requested to the moment when the produced article is stored in the stock. The “L” is a value not smaller than 1. “C” represents a planning cycle which is an object period of the production plan. The “C” is a value not smaller than 1. A “production type flag” represents a production type of the object article of the production plan and stores “ordered” or “forecast”.

An ordered production article parameter table 202 contains parameter information defining a production priority of the ordered production article in the mixed-flow process and is provided for each “article code”. “N” represents a demand take-in period which is a numeric value obtained by adding the supply lead time “L” and the planning cycle “C” in the production plan table 201. “M” represents a maximum demand take-in period, i.e., the upper limit value of the period for taking in the future demand amount of the ordered production article. “m” represents a demand take-in interval, i.e., an enlargement width of the demand take-in period.

A forecast production article parameter table 203 contains parameter information defining a production priority of a forecast production article in the mixed-flow process and is provided for each “article code”. “B” represents a safe stock take-in rate. “A” represents a maximum safe stock take-in rate, i.e., a rate indicating the upper limit for taking in the safe stock amount to the necessary stock amount of the forecast production article. “A” is a decimal not greater than 1. “a” represents a safe stock take-in interval which indicates the enlarged width of the safe stock take-in rate.

A stock table 204 contains stock information on the stock for the date of processing and is provided for each “article code”. “Ia” represents an effective stock amount which is obtained by adding the actual stock amount of the article (available stock amount) and an inventory on order.

An ordered production article calculation table 205 contains information required when calculating a marginal stock rate of an ordered production article and is provided for each “article code”. “D(i)” represents a predicted demand amount which is a future demand amount of the ordered production article determined for each unit period. “D(i)” takes in future demand amounts from “D(1)” to “D (N)”.

“ΣD(N)” (which may also be expressed as “sigma D(N)”) represents a demand take-in amount which is a total of the predicted demand amounts from a unit time to “N” periods. “Ia” represents an effective stock amount obtained by adding the actual stock amount of the article (available stock amount) and the inventory on order. “Rm” represents a marginal stock rate which is obtained by dividing the effective stock amount by the demand take-in amount (Rm=Ia/ΣD(N)).

Demand plan information 216 contains data managed for each “article code”, i.e., holds “D(i)” data which indicates a demand type whether a future demand amount starting from the date of the production planning (today) is definite or indefinite, and is taken into the ordered production article calculation table.

A forecast production article calculation table 206 contains information required when calculating a marginal stock rate of a forecast production article and is provided for each “article code”. “Qd” represents a moving average of demand amount which is an average demand amount per unit period calculated from the actual demand before the production planning date. “σd” represents a moving standard deviation which is the standard deviation of the moving average of demand amount “Qd”. “k” represents a safe stock coefficient used by a production staff for setting a service rate. A generally used value is in the range from 1.0 to 6.0. For example, when the service rate is 95%, it is considered that lack of stock will not occur and k=1.96. “Is” represents a safe stock amount which is obtained by the safe stock coefficient “k”, the moving average of demand amount “Qd, its standard deviation “σd”, the supply lead time “L”, and the planning cycle “C” (Is=k×√(L+C)×σd). “Ik” represents a turnover stock amount obtained by multiplying the moving average of demand amount “Qd” by a total of the supply lead time “L” and the planning cycle “C” (Ik=Qd×(L+C)). “In” represents a necessary stock amount which is obtained by adding the safe stock amount “Is” to the involving stock amount “Ik” (In=Ik+Is). “Ia” represents an effective stock amount which is obtained by adding the actual stock amount of the article (available stock amount) and the inventory on order. “Rm” represents a marginal stock rate which is obtained by dividing the effective stock amount “Ia” by the necessary stock amount “In” (Rm=Ia/In). Actual demand information 217 is a table showing the moving average of demand amount “Qd” required when calculating the marginal stock rate of a forecast production article and manages actual demand data on the past one year.

A marginal stock rate table 207 is used for deciding an article having the minimum marginal stock rate “Rm” among object articles of a production plan. The marginal stock rate table 207 contains “an article code” of the object article of the production plan and the obtained marginal stock rate “Rm”. The “minimum marginal stock rate flag” is initialized to be “OFF”. When an article having the minimum marginal stock rate “Rm” is identified, the “minimum marginal stock rate flag” of the article is turned ON.

A capability distribution candidate table 208 is used for judging whether an article having a minimum marginal stock rate smaller than 1 can be subjected to capability distribution. The priorities of “first rank”, “second rank”, and “third rank” represent priorities in the capability distribution (line allocation) for articles having a minimum marginal stock rate smaller than 1 (for example, the first rank is the second line, the second rank is the first line, and the third rank is the third line).

A capability distribution table 209 contains production plan decision information and displays an article decided to be produced for each “line code” and the production line. “Production amount” stores a result obtained by calculation using a production amount calculation table 213 which will be detailed later.

A previous production article table 210 contains information for identifying an article produced in the preceding production plan and is provided for each “line code”. A “previous production article” indicates an article produced in a corresponding production line in the previous production plan.

A preparation time table 211 is a table in which a preparation time is set when producing an article on a production line. The “preparation time” represents a time required when producing an article different from an article previously produced on the production line, for changing the production line from a previous production article to a current article code such as a jig replacement which is not counted in the proper production activity.

A pitch time table 212 is used to know a pitch time required when an article is produced on a production line. The “pitch time” is time required for producing one piece of article.

A production amount calculation table 213 contains information required for calculating a production amount of the production line and the article decided to be produced and the table is provided for each “line code”. “Operation time” is information obtained by referencing an operation time table 215 which will be detailed later and represents time during which the production line can be operated for performing production. “Minimum lot size” is information obtained from a lot size table 214 which will be detailed later and represents a quantity when the minimum quantity of a production lot is decided.

The lot size table 214 is provided for each “article code” for indicating the minimum quantity of the production lot when producing the article. The operation time table 215 is provided for each “line code” and indicates an operation time during which a line can operate on a certain date. Demand plan information 216 is a table in which a demand amount and a demand type for each article code are managed according to a date. The actual demand information 217 is a table managed by the “article code” and containing the past actual demand data.

The data shown in FIG. 3 includes master data and transaction data obtained during processing. The master data is data set for planning a production and data set as an initial value such as the initial value of the demand take-in period “N” in the production plan table 201 and the ordered production article parameter table 202, the initial value of the safe stock take-in rate “B” in the forecast production article parameter table 203, the moving average of demand amount “Qd”, the moving standard deviation “σd”, the safe stock amount “Is”, the necessary stock amount “In”, and the effective stock amount “Ia” in the forecast production article calculation table, as well as the capability distribution candidate table 208, the preparation time table 211, the pitch time table 212, the lot size table 214, the operation time table 215, and the like. These master data are inputted via the input device 4 or obtained by operation from statistical data.

FIG. 4 shows an outline of the entire procedure of the production planning according to the present embodiment. By the process of a data access program, the storage device 2 is accessed so as to enable data reading. By the process of a data input program 11, data inputted from the input device or a computer/terminal 7 is received. The data received here is data required for starting creation of a production plan such as information on article specification and a used process (not depicted).

Next, a production type judging program 12 makes a judgment to determine whether the object article is an ordered production article or a forecast production article by referencing the production type flag in the production plan table 201. According to the result of the judged production type, a process defined by the ordered production article calculation program 13 or the forecast production article calculation program 14 is performed. The process of the ordered production article calculation program 13 calculates a marginal stock rate of the ordered production article and stores the calculation result into the marginal stock rate table 207 (step 34). The process of the forecast production article calculation program 14 calculates a marginal stock rate of the forecast production article and stores the calculation result into the marginal stock rate table 207 (step 35).

Subsequently, the process of the minimum marginal stock rate judging program 15 is executed and an article having the minimum marginal stock rate among the object articles in the production plan stored in the marginal stock rate table 207 is stored as a candidate of capability distribution into the distribution candidate table 208 (step 36). The process of the capability distribution decision program 16 judges to which line the article of the line distribution candidate is to be distributed according to the distribution candidate table 208 and stores the judgment result into the distribution result table 209 (step 37). The process of the production amount calculation program 17 calculates a production amount of the article for which line distribution is decided from the distribution result table 209, the previous production article table 210, and the preparation time table 211 and stores the calculation result into the distribution result table 209 (step 38). The process of the production plan output program 18 outputs the data stored in the distribution result table 209 to the display device 3 or the printer 5 (step 39).

By setting the marginal stock rate capable of equally evaluating the production priority for the ordered production article and the forecast production article as a parameter, it is possible to easily and automatically set the production priority.

FIG. 5 is a flowchart showing a flow of detailed processes of step 33. The process of the production type judging program 12 judges whether the “production type flag” is an “ordered” article or “forecast” article for each of the “article codes” held in the production plan table 201 (step 51). If the “production type flag” is “ordered”, it is stored in the ordered production article parameter table 202 according to the process of the ordered production article calculation program 13. If the “production type flag” is “forecast”, it is stored in the forecast production article parameter table 203 according to the process of the forecast production article calculation program 14. After this, respective processes are executed.

FIG. 6 is a flowchart showing a flow of detailed processes of step 34. The process of the ordered production article calculation program 13 firstly judges whether the demand take-in period “N” stored in the ordered production article parameter table 202 is not greater than the maximum demand take-in period “M” (step 61).

If the demand take-in period “N” is greater the maximum demand take-in period, the process of the production plan output program 18 is executed. If the demand take-in period “N” is not greater the maximum demand take-in period, an ordered production article calculation table 205 is created by using the ordered production article parameter table 202, the stock table 204, and the demand plan information 216 corresponding to the “article code” (step 62). The predicted demand amount “D(i)” in the ordered production article calculation table 205 corresponding to the “article code” of the ordered production article parameter table 202 is stored for N periods (step 63).

The predicted demand amount “D(i)” indicates a definite demand amount for each unit period. A predicted demand amount for N periods from the date of creation of the production plan is taken in from the demand plan information 216, and

it is stored in the demand take-in amount “ΣD(N)” (step 64). The effective stock amount “Ia” in the stock table 204 corresponding to the “article code” of the ordered production article parameter table 205 is stored in the effective stock amount “Ia” of the ordered production article calculation table 205 (step 65). The effective stock amount is a total obtained by adding the stock in hand of the process and the stock available on the stock storage point, which is an actual stock amount before creating a production plan. A marginal stock rate obtained by dividing the effective stock amount “Ia” by the demand take-in amount “ΣD(N)” is stored in the marginal stock rate “Rm” in the ordered production article calculation table 205 (step 66).

As for the ordered production article, a stock which can be delivered upon shipment is required. By assuming that the stock of that amount (demand take-in amount) is a necessary stock amount and the currently completed amount is an effective stock amount, a marginal stock rate (effective stock amount/demand take-in amount) can be indexed. If the marginal stock rate “Rm” is not smaller than 1, the current effective stock amount is sufficient and there is no need of producing the ordered production article any more. Since the maximum demand take-in period “M” is set, it can be used as a standard for deciding how much consideration should be taken on the future demand of the ordered production article in performing production.

When the maximum demand take-in period “M” is set longer, a risk of having a stock increases but the possibility of lack of article is lowered. On the contrary, when the M is set shorter, there is no risk of having a stock but the possibility of lack of article is increased. For this, the maximum demand take-in period “M” can reflect the concept of an enterprise concerning the stock and the lack of article.

FIG. 7 is a flowchart showing a flow of detailed processes of step 35. The process of the forecast production article calculation program 14 judges whether the safe stock take-in rate “B” stored in the forecast production article parameter table 203 is not greater than the maximum safe stock take-in rate “A” (step 71).

If the safe stock take-in rate “B” is greater than the maximum safe stock take-in rate “A”, the process of the production plan output program 18 is executed. If the safe stock take-in rate “B” is not greater than the maximum safe stock take-in rate “A”, a forecast production article calculation table 206 is created by using the forecast production article parameter table 203 and the stock table 204 corresponding to the “article code” (step 72).

The moving average of demand amount “Qd”, the standard deviation “σd”, and the safe stock coefficient “k” of the forecast production article calculation table 206 corresponding to the “article code” of the forecast production article parameter table 203 are stored (step 73). The safe stock amount is calculated by (k×√(L+C)×σd) and stored in the safe stock amount “Is” in the forecast production article calculation table 206 (step 74). The turnover stock amount is calculated by (Qd×(L+C)) and it is stored in the turnover stock amount “Ik” in the forecast production article calculation table 206.

Next, the necessary stock amount is calculated by (Ik+B×Is) and stored in the necessary stock amount “In” in the forecast production article calculation table 206 (step 76). The effective stock amount “Ia” of the stock table 204 corresponding to the “article code” of the forecast production article parameter table 206 is stored in the effective stock amount “Ia” of the forecast production article calculation table (step 77). The marginal stock rate obtained by dividing the effective stock amount “Ia” by the necessary stock amount “In” is stored in the marginal stock amount “Rm” of the forecast production article calculation table 206 (step 78). If the marginal stock rate “Rm” is not smaller than 1, the current effective stock amount is sufficient and there is no need of producing the forecast production article any more.

Since the maximum safe stock take-in rate “A” is set, it can be used as a standard to decide how much consideration should be taken on possibility of lack of article due to a change of demand for the forecast production article. When the maximum safe stock take-in rate “A” is set higher, the risk of having a stock increases but the possibility of lack of article is lowered. On the contrary, when the maximum safe stock take-in rate “A” is set lower, there is no risk of having a stock but the possibility of lack of article is increased. For this, the maximum safe stock take-in rate “A” reflects the concept of an enterprise concerning the stock and the lack of article.

FIG. 8 is a flowchart showing a flow of detailed processes of step 36. The process of the minimum marginal stock judgment program 15 firstly creates a marginal stock rate table 207 for correlating the marginal stock rate obtained by steps 34 and step 35 to respective production articles (step 81). As data, the marginal stock rate “Rm” corresponding to the “article code” of the ordered production article calculation table 205 and “Rm” corresponding to the forecast production article calculation table are stored in the marginal stock rate table 207 (step 82). Judgment is made to decide the “article code” having the minimum marginal stock rate “Rm” among the marginal stock rates “Rm” of the “article codes” stored in the marginal stock rate table 207. For the minimum “Rm”, the “minimum marginal stock rate flag” is turned ON (step 83). Then, judgment is made to decide whether the marginal stock rate “Rm” of the “article code” for which “the minimum marginal stock rate flag” is ON is smaller than 1 (step 84).

When the marginal stock rate “Rm” is smaller than 1, the column of the corresponding “article code” in the capability distribution candidate table 208 is referenced. When the marginal stock rate “Rm” is not smaller than 1, the stock amount before creation of the production plan suffices the demand and there is no need of production. For this, the production plan for the production article is recreated. Judgment is made to decide whether the “article code” stored in the marginal stock rate table 207 is an ordered production article or a forecast production article according to the “production type flag” in the production plan table 201.

If the “production type flag” in the production plan table 201 is “ordered”, the demand take-in interval “m” is added to the demand take-in period “N” in the ordered production article parameter table 202 and the addition result is stored (step 86). For example, the demand take-in interval “m” may be increased from the demand take-in period “N” stepwise by one day or two days, or it is possible to increase “m” from one day, to two days, and then to three days. In the ordered production article parameter table of FIG. 12, the demand take-in interval m is set to 1. The value after the addition is stored in the demand take-in period “N” of the ordered production article parameter table 202 and then the process of the ordered production article calculation program 13 (FIG. 6) is executed again.

If the “production type flag” is “forecast”, the safe stock take-in interval “a” is added to the safe stock take-in period “B” in the forecast production article parameter table 203 and the addition result is stored (step 87). For example, the safe stock take-in interval “a” may be increased stepwise by 0.1. It is also possible to increase “a” stepwise such as 0.1, 0.2, 0.3, 0.4 or decrease “a” stepwise such as 0.4, 0.3, 0.2, 0.1. In the forecast production article parameter table 203 of FIG. 12, the safe stock take-in interval “a” is set to 0.2. The value after the addition is stored in the safe stock take-in period “B” of the forecast production article parameter table 203 and then the process of the forecast production article calculation program 14 (FIG. 7) is executed again.

By setting the demand take-in interval “m”, the production planner can reflect the production priority of the ordered production article in the mixed-flow production process where an ordered production article and a forecast production article are mixed. By setting the safe stock take-in interval “a”, the production planner can reflect the production priority of the forecast production article in the mixed-flow production process where an ordered production article and a forecast production article are mixed.

FIG. 9 is a flowchart showing a flow of detailed processes of step 37. The process of the capability distribution decision program 16 references a column of the capability distribution candidate table 208 corresponding to the “article code” for which “the minimum marginal stock rate flag” is ON in the marginal stock rate table 207 (step 901) and acquires information on the production line of “the first rank” in the priority of the capability distribution corresponding to the “article code” of the capability distribution candidate table 208. It is judged whether another article code has been allocated for the “line code” corresponding to the production line in the capability distribution result table 209 (step 902).

If no other code is allocated (No in step 902), the “article code” (the article code in step 901) is stored for the “line code” corresponding to the production line in the capability distribution result table 209 (step 903) and the process of the production amount calculation program 17 is executed. Moreover, if another article code is allocated (Yes in step 902), it is judged whether a production line of “the second rank” in the priority of the capability distribution corresponding to the “article code” exists in the capability distribution candidate table 208 (step 904).

If the judgment result is that no production line of “the second rank” in the priority exists (No in step 904), “the minimum marginal stock rate flag” corresponding to the “article code” in the marginal stock rate table is turned “OFF”, 10000 is stored in the marginal stock rate “Rm” (step 905), the process of the minimum marginal stock rate judgment program 15 (FIG. 8) is executed, and the capability distribution decision process of FIG. 9 is executed from the beginning for a new article code to be obtained. If the judgment result is that a production line of “the second rank” in the priority of capability distribution exists for the “article code” in the capability distribution candidate table 208 (Yes in step 904), it is judged whether any other article code has been allocated for the “line code” corresponding to the production line of the second rank in the capability distribution result table (209) (step 906).

If no other article code is allocated (No in step 906), the “article code” (the article code in step 901) is stored for the “line code” corresponding to the production line in the capability distribution result table 209, the production amount which can be produced by the line is calculated and stored (step 903), and the process of the production amount calculation program 17 is executed. Moreover, if any other article code is allocated (Yes in step 906), it is judged whether a production line of “the third rank” in the priority of the capability distribution corresponding to the “article code” exists in the capability distribution candidate table 208 (step 908).

If the judgment result is that no production line of “the third rank” of the priority exists (No in step 908), “the minimum marginal stock rate flag” corresponding to the “article code” in the marginal stock rate table 207 is turned “OFF” and 10000 is stored in the marginal stock rate “Rm” (step 905). Then, the process of the minimum marginal stock rate judging program 15 (FIG. 8) is executed and the capability distribution decision process of FIG. 9 is executed from the beginning for a new article code to be obtained. If a production line of “the third rank” in the priority of the capability distribution exists for the “article code” of the capability distribution candidate table 208 (Yes in 908), it is judged whether any other article code has been allocated for the “line code” corresponding to the production line of the third rank in the capability distribution result table (step 910).

If no other article code is allocated (No in step 910), the “article code” (the article code in step 901) is stored for the “line code” corresponding to the production line in the capability distribution result table 209 and the production amount of the article which can be produced by the line is calculated and stored (step 903) and the process of the production amount calculation program 17 is executed. The capability distribution candidate table 208 contains a capability distribution priority rank for each of the articles. However, depending on the characteristic of an article, the capability may not be distributed to all the production lines. For this, it is checked whether a line of lower capability distribution priority rank corresponding to the “article code” exists before referencing the distributed line in the capability distribution result table 209. If no production line which can be distributed exists for an article in the capability distribution candidate table 208, the article is defined as an article out of the production plan. Then, it is checked whether any article other than this has a marginal stock rate “Rm” smaller than 1. For this, 10000 greater than 1 is stored in the marginal stock rate “Rm” of the article so as to perform control that the article will not become an object article of capability distribution.

FIG. 10 is a flowchart showing a flow of detailed processes of step 38. The process of the production amount calculation program 17 stores in the preparation time table 211, “the previous production article” corresponding to “the line code” in the capability distribution result table 209 from the previous production article table 210 containing “the previous production article” corresponding to each “line code” (step 1001). “The article code” of the capability distribution result table is stored in the preparation time table 211 (step 1002). “The preparation time” corresponding to “the article code” of the capability distribution result table 209 is stored in the production amount calculation table 213 (step 1003). “The minimum lot size” corresponding to “the article code” of the capability distribution result table 209 is stored in the production amount calculation table 213 (step 1004). “The operation time” corresponding to “the line code” of the capability distribution result table 209 is stored in the production amount calculation table 213 (step 1005). “The pitch time” corresponding to “the line code” and “the article code” in the capability distribution result table 209 is stored in the production amount calculation table 213 (step 1006).

A calculation of ((“operation time”−“preparation time”)/pitch time) is executed and a production amount taking the lot size restriction (such as round-off) into consideration is stored in “the production amount” in the production amount calculation table 213 (step 1007). “The production amount” is added to the effective stock amount “Ia” in the stock table 204 corresponding to “the article code” of the production amount calculation table 213 and the addition result is stored (step 1008). Here, “the production amount” after decision of production can be considered to be an effective stock amount. “The production amount” corresponding to “the line code” in the production amount calculation table is stored in the capability distribution result table 209 (step 1009). Next, check is made whether all the items in the capability distribution result tables 209 are stored (step 1010). If any item is missing in the capability distribution result table 209, the process of the production type judging program 12 is executed. If all the items of the capability distribution result table 209 are stored, “the line code” and “the article code” of the capability distribution result table 209 are written and stored in the previous production article table 210 (step 1011).

FIG. 11 is a flowchart showing a flow of detailed processes of step 39. The process of the production plan output program 18 outputs the entire capability distribution result table 209 to the printer 5 (step 1101). Moreover, the capability distribution result table 209 is sent to each of the computers/terminals 7 (step 1102). At the production site, as the contents of the capability distribution result table 209, an article code and article name, if necessary, to be produced by a line name to be operated on the day when the production plan is made and a production amount of the article are displayed on an output screen (not depicted) constituting the computers/terminals 7 or outputted on a sheet of paper by the printer.

The present invention may be applied to a production planning method and a production planning system for performing mixed-flow production in which an ordered production article and a forecast production article are involved.

### BRIEF DESCRIPTION OF DRAWINGS

FIG. 1 is a block diagram showing configuration of a computer for executing a production planning process according to the embodiment.

FIG. 2 shows a presupposed model of the embodiment.

FIG. 3 shows a data configuration of the embodiment.

FIG. 4 shows an outline of the procedure of the production planning of the embodiment.

FIG. 5 is a flowchart showing a flow of processes of the production type judging unit of the embodiment.

FIG. 6 is a flowchart showing a flow of processes of the ordered production article calculation unit of the embodiment.

FIG. 7 is a flowchart showing a flow of processes of the forecast production article calculation unit of the embodiment.

FIG. 8 is a flowchart showing a flow of processes of the minimum marginal stock rate judging unit of the embodiment.

FIG. 9 is a flowchart showing a flow of the processes of the capability distribution decision unit of the embodiment.

FIG. 10 is a flowchart showing a flow of processes of the production amount calculation unit of the embodiment.

FIG. 11 is a flowchart showing a flow of the process of the production plan output unit of the embodiment.

FIG. 12 shows tables constituting the production plan data.

FIG. 13 shows tables constituting the production plan data.

FIG. 14 shows tables constituting the production plan data.

FIG. 15 shows a table constituting the production plan data.

FIG. 16 shows a table constituting the production plan data.

FIG. 17 shows tables constituting the production plan data.

FIG. 18 shows a table constituting the production plan data.

FIG. 19 shows tables constituting the production plan data.

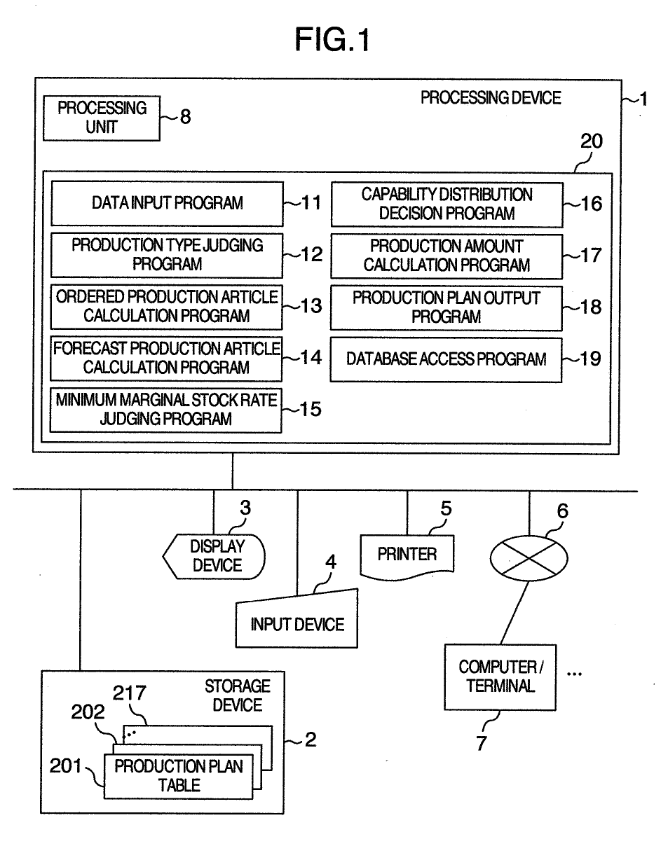

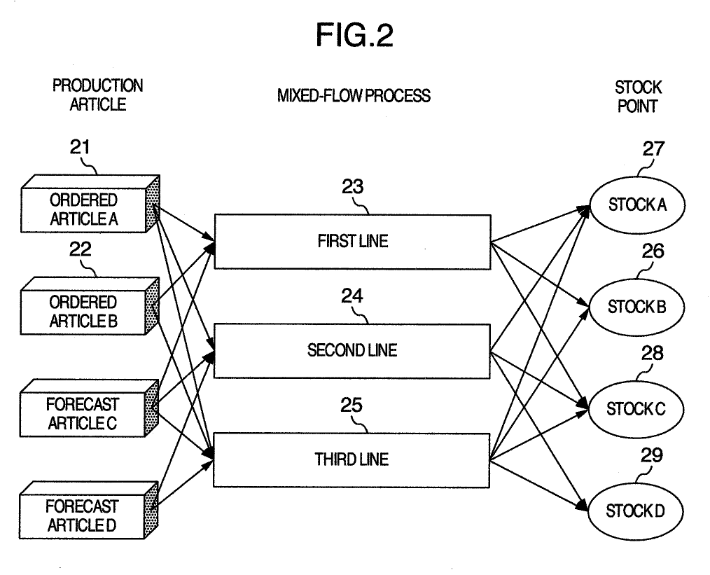

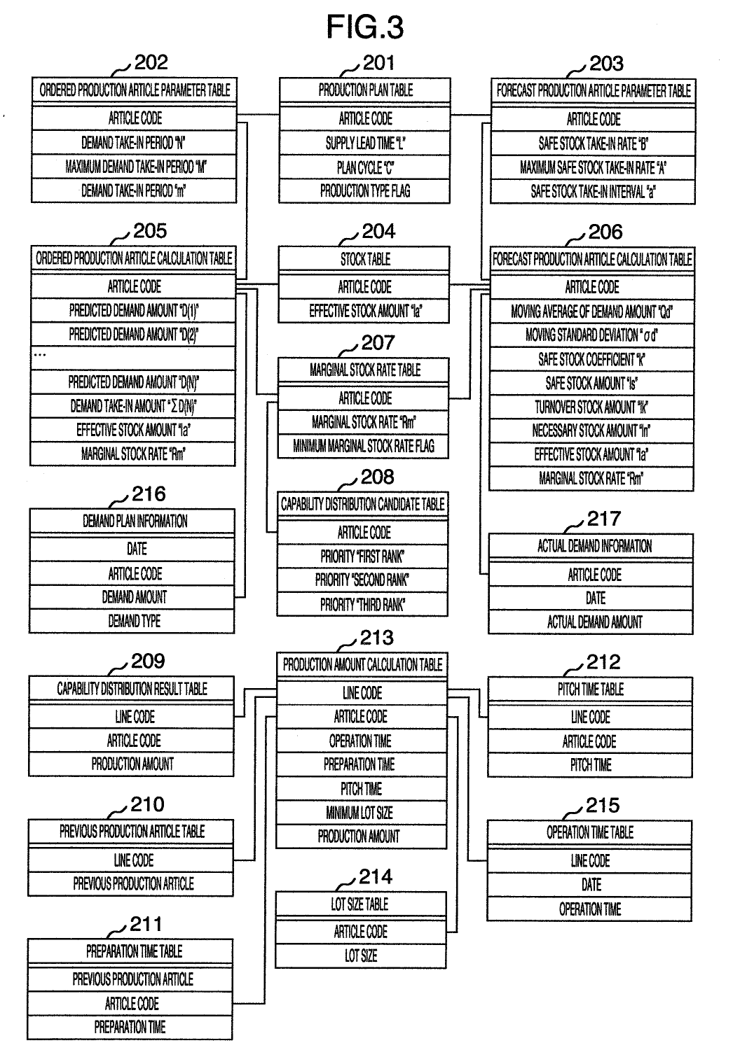

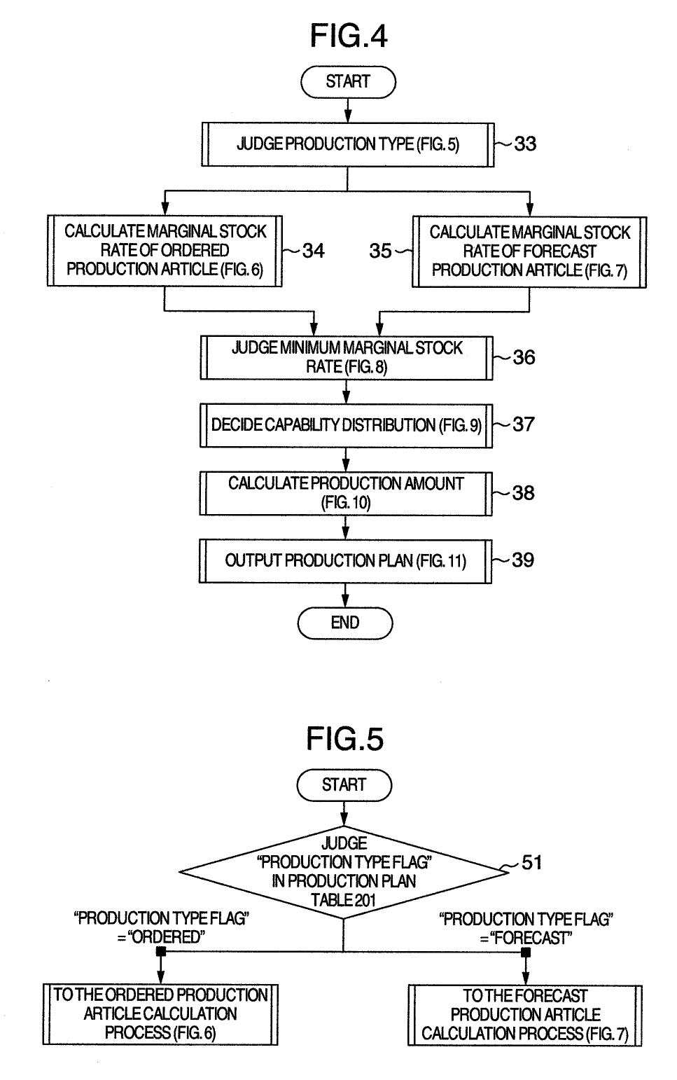

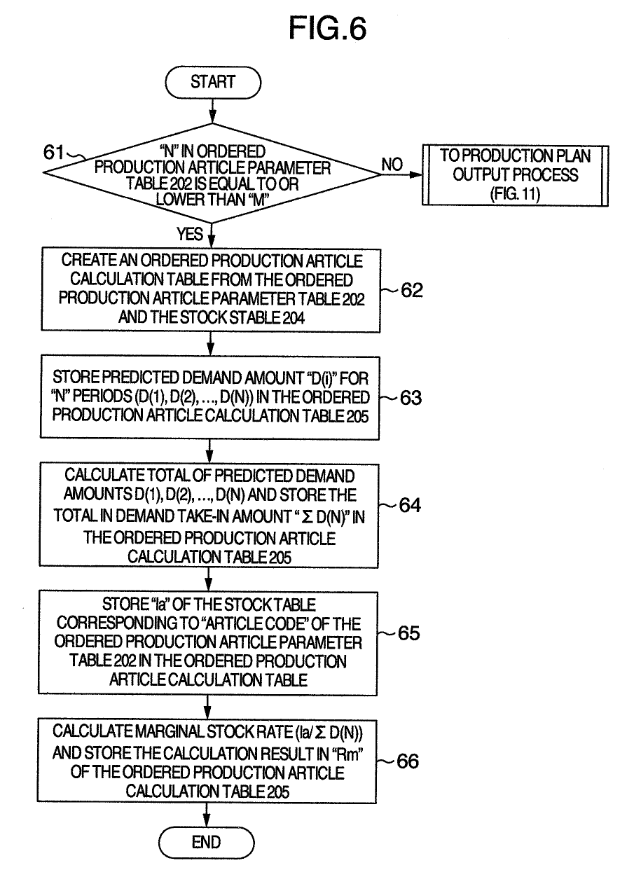

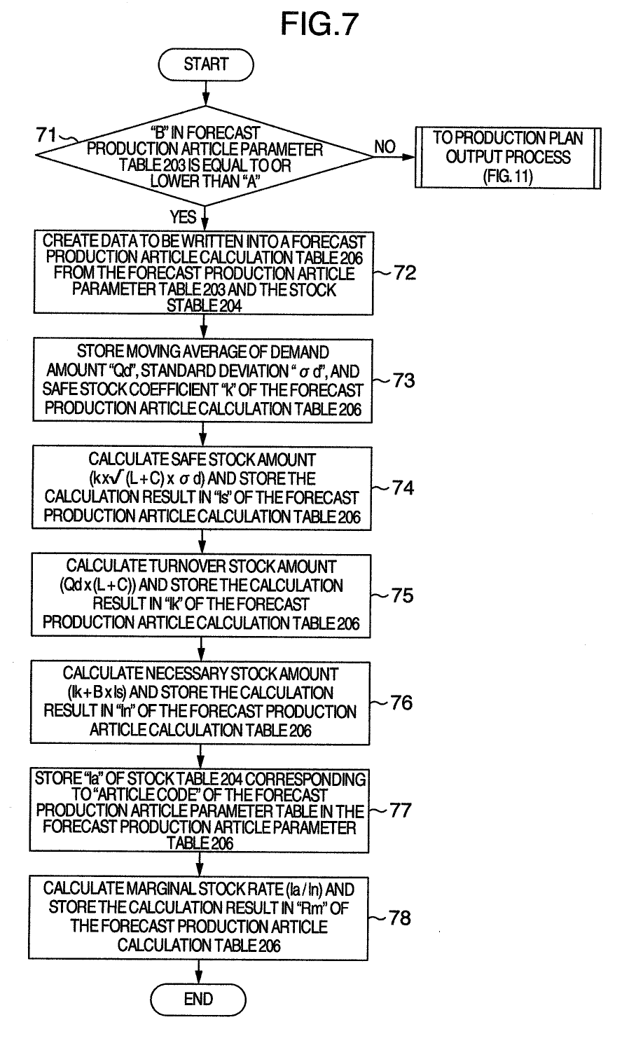

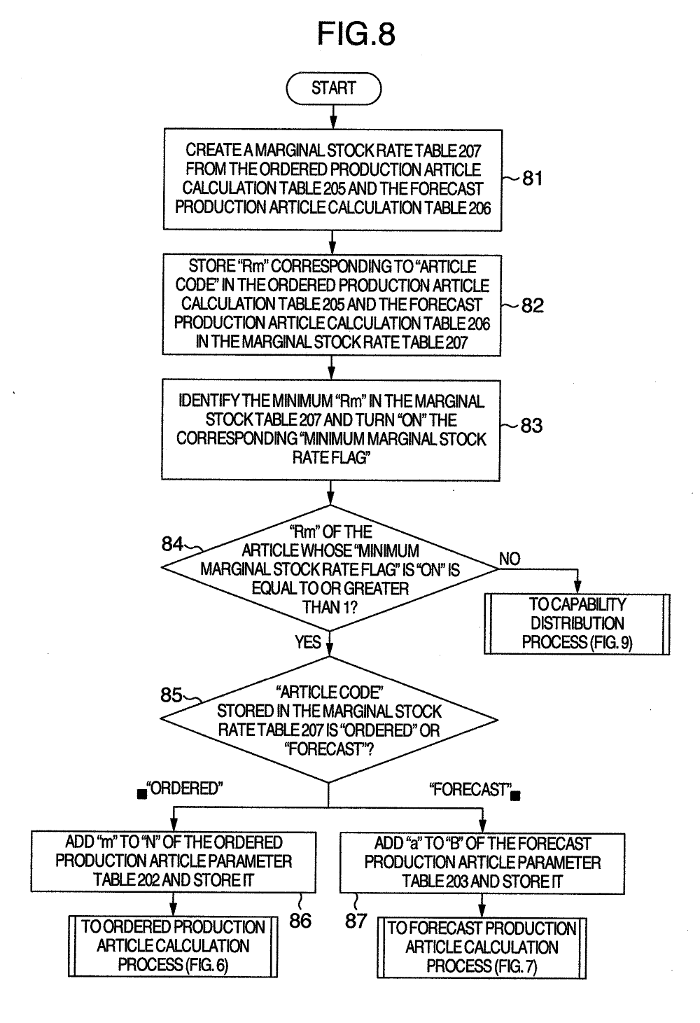

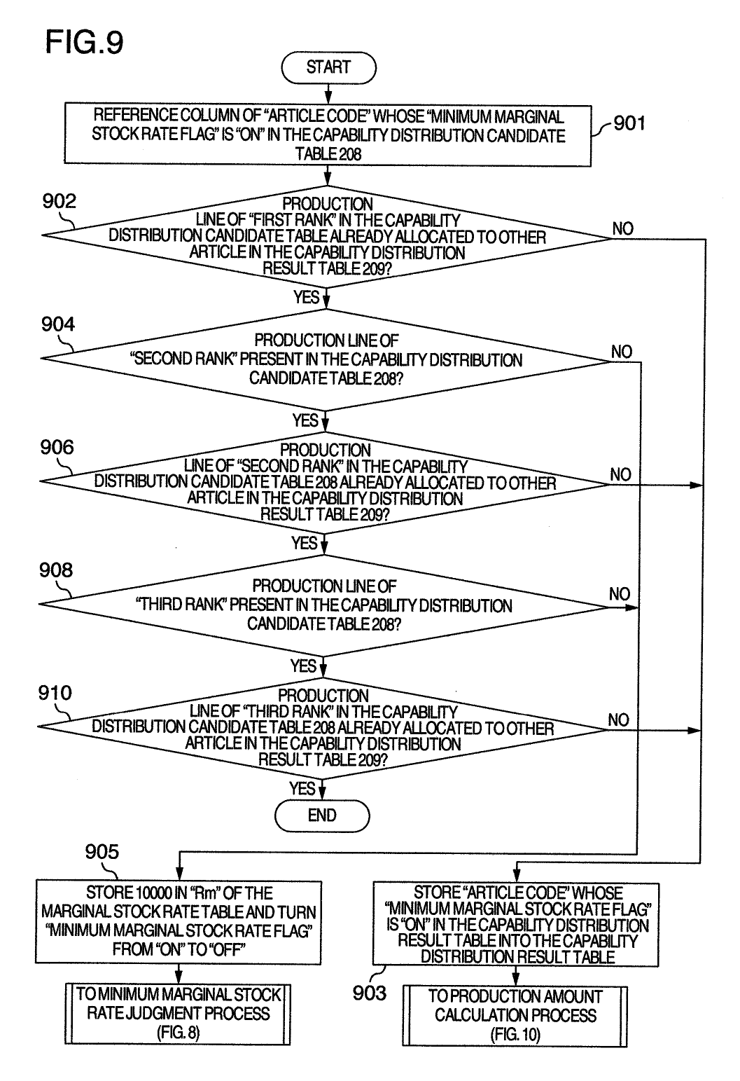

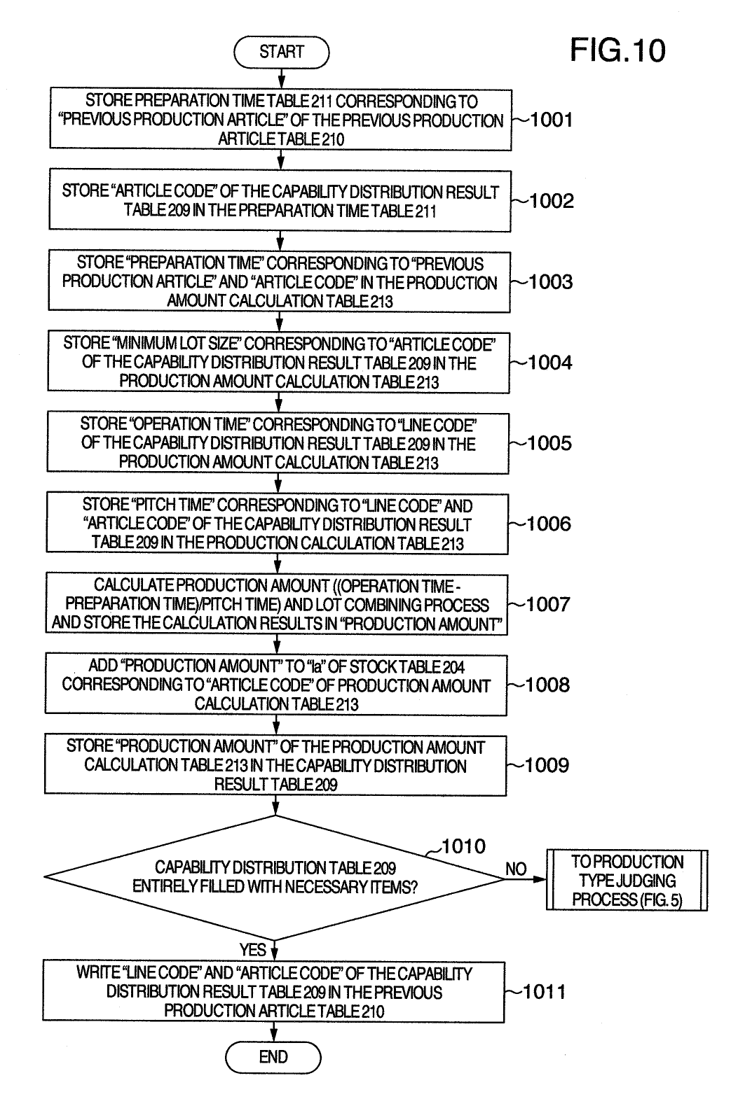

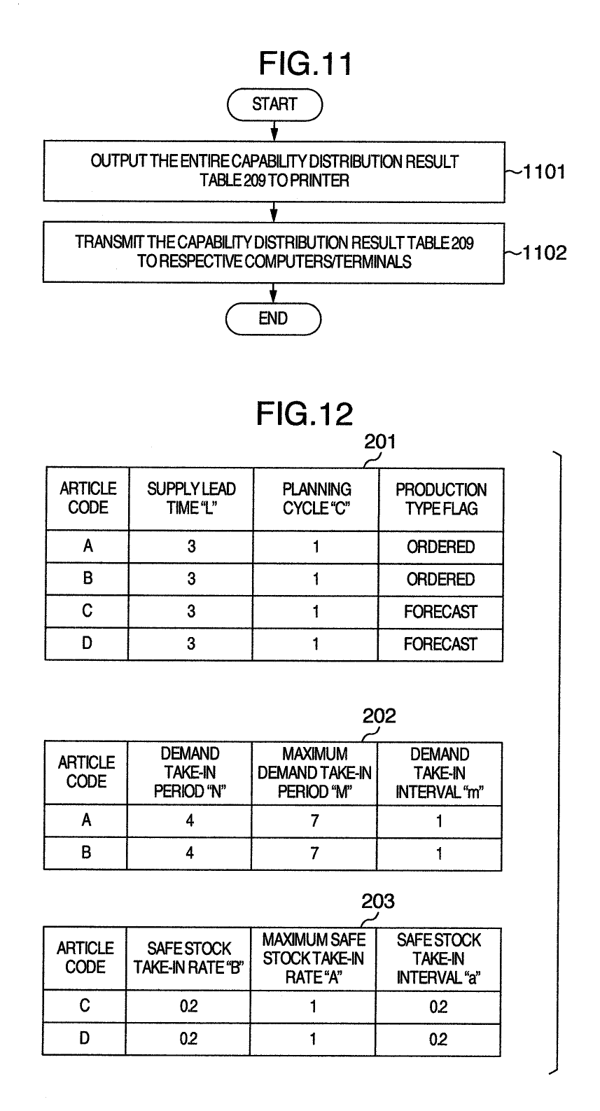

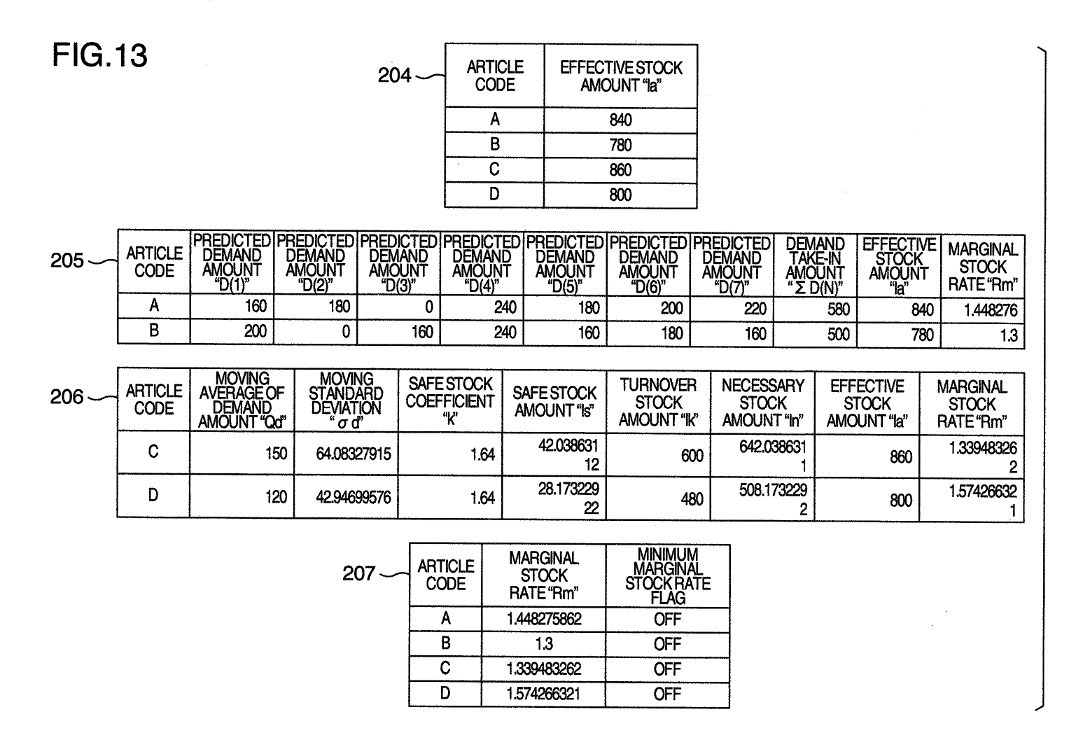

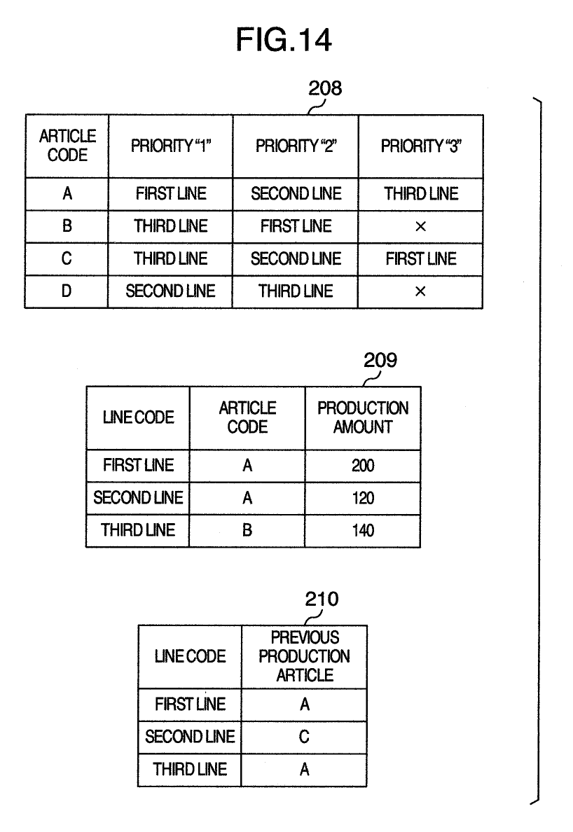

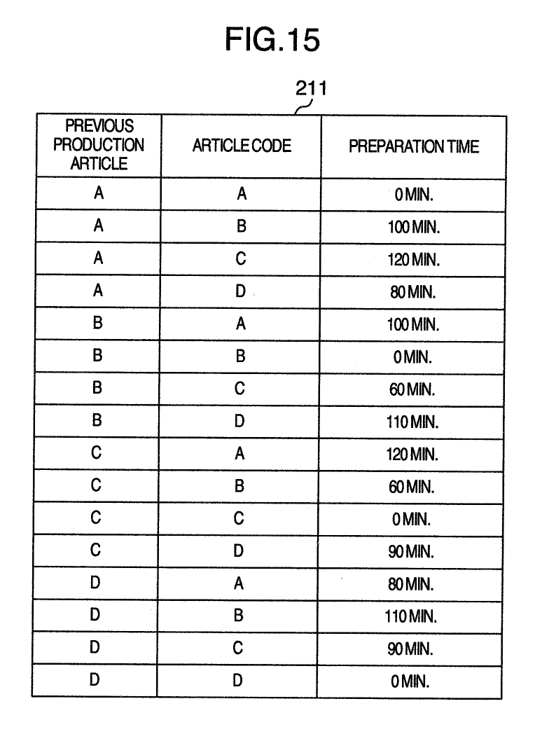

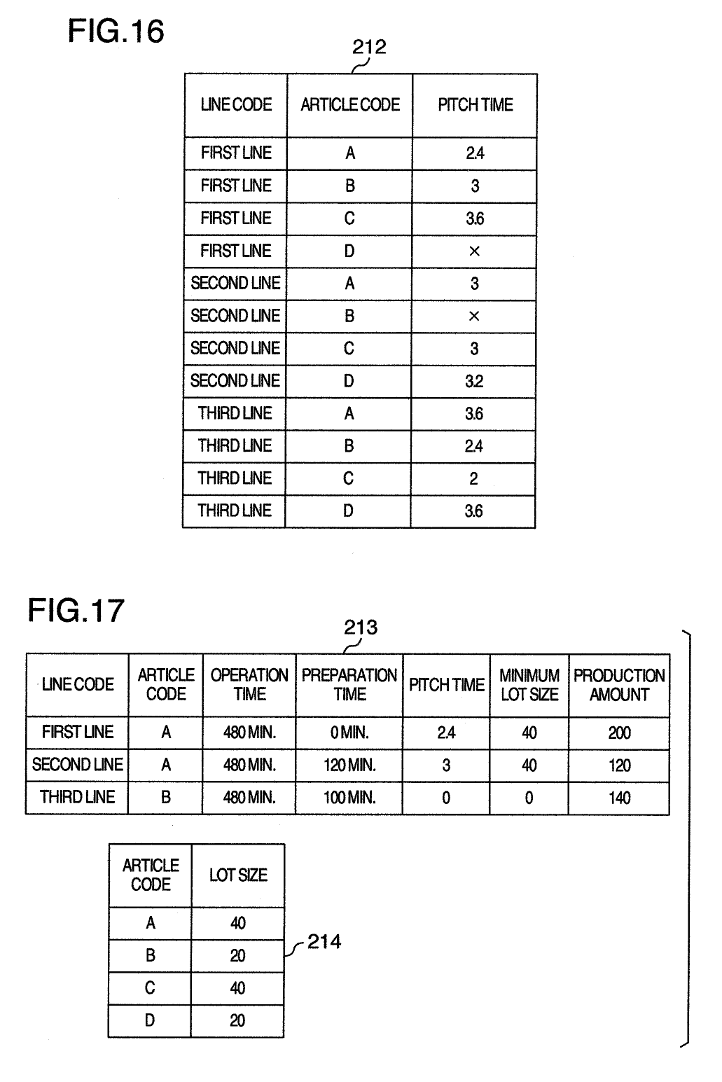

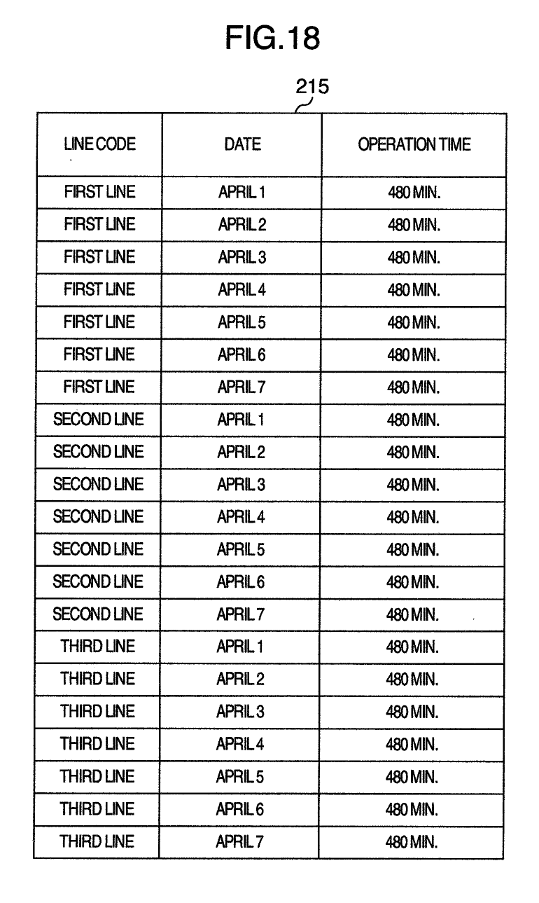

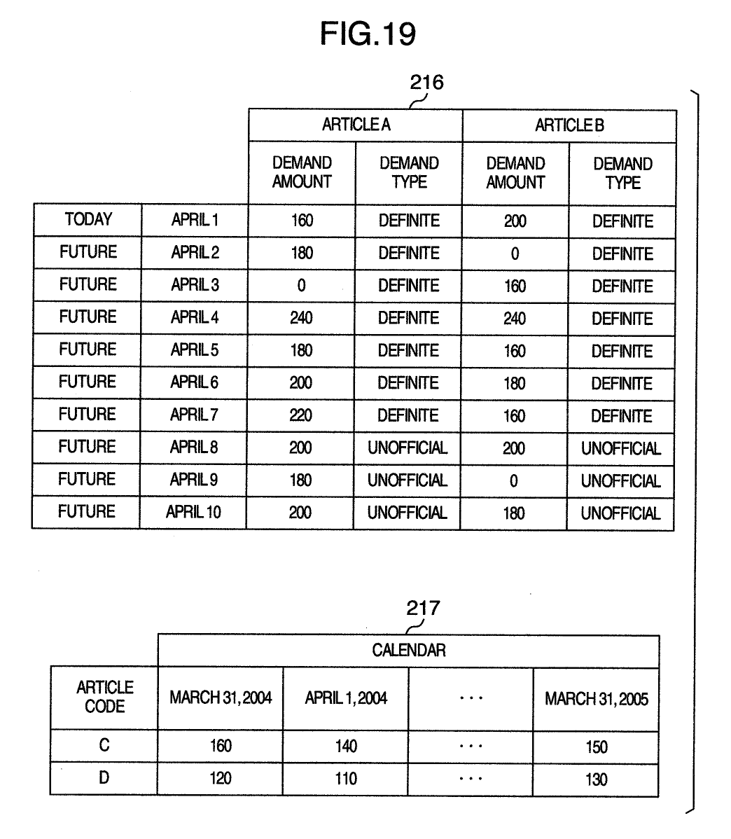

1. A production planning method using data required for production planning and production planning programs for creating a production plan of a production process where an ordered production article and a forecast production article flow in a mixed way by using a computer, the method comprising steps of:
inputting data on a necessary amount of an ordered production article and a forecast production article and actual stock amount data into a processing unit of a computer;
judging a production type of a production article for which a production plan is to be created;
acquiring a parameter defining a production priority decided in accordance with the production type according to a relationship between actual stock data and necessary stock amount data;
deciding a production line capability distribution for the production article if the parameter is lower than a predetermined value; and
deciding a new production amount obtained by adding a production amount on a production line distributed by the capability distribution for the production article.

2. The production planning method as claimed in claim 1, the method further comprising steps of:
writing a parameter used when the production article is an ordered production article and a parameter used when the production article is a forecast production article into one parameter table;
comparing values of the parameters which have been written and identifying a parameter of a minimum value;
recalculating all the parameters if the identified parameter is not smaller than the predetermined value; and
identifying a value having a minimum value among the parameters written into the parameter table and comparing it to the predetermined value.

3. The production planning method as claimed in claim 1, wherein
the parameter is a marginal stock rate obtained by (effective stock amount/demand take-in amount) at a predetermined stock point when the production article is an ordered production article; and
the parameter is a marginal stock rate obtained by (effective stock amount/necessary stock amount) at a predetermined stock point when the production article is a forecast production article.

4. The production planning method as claimed in claim 3, wherein in the recalculation of the marginal stock rate of the ordered production article, the marginal stock rate is calculated by dividing the effective stock amount by a total of a demand amount of a preset demand take-in interval and the demand take-in amount.

5. The production planning method as claimed in claim 2, wherein
the parameter is a marginal stock rate obtained by (effective stock amount/demand take-in amount) at a predetermined stock point when the production article is an ordered production article; and
the parameter is a marginal stock rate obtained by (effective stock amount/necessary stock amount) at a predetermined stock point when the production article is a forecast production article.

6. The production planning method as claimed in claim 5, wherein in the recalculation of the marginal stock rate of the ordered production article, the marginal stock rate is calculated by dividing the effective stock amount by a total of a demand amount of a preset demand take-in interval and the demand take-in amount.

7. The production planning method as claimed in claim 3, wherein
the effective stock amount is an actual stock before creation of the production plan;
the demand take-in amount is a total value of predicted demand amounts for N periods from the point of creation of the production plan; and
the necessary stock amount is obtained from a turnover stock amount and a safe stock amount based on past statistical data.

8. The production planning method as claimed in claim 5, wherein
the effective stock amount is an actual stock before creation of the production plan;
the demand take-in amount is a total value of predicted demand amounts for N periods from the point of creation of the production plan; and
the necessary stock amount is obtained from a turnover stock amount and a safe stock amount based on past statistical data.

9. The production planning method as claimed in claim 1, wherein the predetermined value is 1.

10. The production planning method as claimed in claim 2, wherein the predetermined value is 1.

11. A production planning method for creating a production plan where an ordered production article and a forecast production article are mixed, the method comprising steps of:
reading production plan data on an ordered production article and a forecast production article;
acquiring an index value indicating a stock amount at an arbitrary stock point by calculation processes different between the ordered production article and the forecast production article;
storing the index value for all the production articles for which a production plan is to be created in one table; and
deciding a production line and a production amount for producing a production article having an index value stored in the table which is below a predetermined value.

12. The production planning method as claimed in claim 11, wherein
the index value of the ordered production article is defined by ([effective stock amount la]/[demand take-in amount ΣD(N)]);
the index value of the forecast production article is defined by ([effective stock amount la]/[necessary stock amount In]); and
the demand take-in amount is a sum of predicted demand amount D(N) for demand take-in period N, and the necessary stock amount is In=Qd×(L+C)+B(k√(L+C)×σd), where Qd is a moving average of demand amount, σd is a moving standard deviation, k is a safe stock coefficient, L is a supply lead time, C is a planning cycle, and B is a safe stock take-in rate.

13. The production planning method as claimed in claim 12, wherein if the index value is not smaller than 1, recalculation is performed by replacing the index value of the ordered production article by N=N+[demand take-in period m] and replacing the index of the forecast production article by B=B+[safe stock take-in interval a].

14. Production planning system for mixed flows of production of an ordered production article and a forecast production article by using a computer, the system comprising:
a processing device including a processing unit and a first storage device for holding a processing program for production planning which is read out into the processing unit and executed,
a second storage device for holding data processed by the processing program,
an input device, and
an output device,
wherein the processing program includes:
a data input program for inputting data from the second storage device and from outside;
a production type judging program for judging a production type of a production article for which a production plan is to be created, i.e., whether it is an ordered production article or a forecast production article;
an ordered production article calculation program to obtain a marginal stock rate (1) for production article whose production type is judged to be an ordered production;
a forecast production article calculation program to obtain a marginal stock rate (2) for production article whose production type is judged to be a forecast production article;
a minimum marginal stock rate judging program for writing the marginal stock rate (1) and the marginal stock rate (2) in a single table and identifying a production article corresponding to a marginal stock rate which is minimum and smaller than 1;
a capability distribution program for allocating a production process for the identified production article; and
a production amount calculation program for deciding a production amount of the identified production article in the allocated production process.

15. The production planning system as claimed in claim 14, wherein the single table is a marginal stock rate table stored in the second storage device and having items of an article code of a production article as an object of the production planning, a marginal stock rate of the production article, and a minimum marginal stock rate flag indicating that the marginal stock rate is less than 1 and a minimum value when compared to a marginal stock rate of other article code.

16. The production planning system as claimed in claim 15, wherein the marginal stock rate is recalculated for a production article having a marginal stock rate not smaller than 1 in the marginal stock rate table.

17. The production planning system as claimed in claim 14, wherein
the second storage device includes an ordered production article parameter table having items of an article code of an ordered production article as an object of the production planning, a demand take-in period “N” indicating a period to be considered as a future stock of the ordered production article, a maximum demand take-in period “M” which can be taken in as a future stock, and a demand take-in interval “m” indicating a unit addition value of the demand take-in period “N”, and
the ordered production article calculation program divides the effective stock amount as an actual available amount by the demand stock amount indicating the necessary amount in the demand take-in period “N” so as to obtain the marginal stock rate (1).

18. The production planning system as claimed in claim 17, wherein the marginal stock rate (1) is recalculated for an ordered production article having a marginal stock rate not smaller than 1 in the marginal stock rate table by replacing N by N+m.

19. The production planning system as claimed in claim 14, wherein
the second storage device includes a forecast production article parameter table having items of an article code of a forecast production article as an object of the production planning, a safe stock take-in rate “B” indicating a rate of consideration on the safe stock amount of the forecast production article, a maximum safe stock take-in rate “A” indicating a rate of a safe stock which can be considered, and a safe stock take-in interval “a” indicating a unit addition value of the safe stock take-in rate “B”, and
the forecast production article calculation program divides the effective stock amount as an actual available amount by the necessary stock amount as a total of a turnover stock amount obtained according to actual past demand data and a stock amount taken-in from the safe stock amount by the safe stock take-in rate “B” so as to obtain the marginal stock rate (2).

20. The production planning system as claimed in claim 19, wherein for a forecast production article having a marginal stock rate not smaller than 1 in the marginal stock rate table, the marginal stock rate (2) is recalculated by replacing A by A+a.
